(19) United States
(12) Patent Application Publication
(10) Pub. No.: US 2005/0171620 A1
(43) Pub. Date: Aug. 4, 2005

(54) Mobile storage apparatus with temperature detecting function

(76) Inventor: Yueh Wen Hsiang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/768,046

(22) Filed: Feb. 2, 2004

(51) Int. Cl. G11B 5/74

(52) U.S. Cl. 700/13

(57) ABSTRACT

A mobile storage apparatus with temperature detecting function has a detecting element, a transforming circuit, a control circuit, and a mobile storage device. A digital signal processor set in the mobile storage device is connected to a liquid crystal display. Further, the digital signal processor is also connected to output ports of the transforming circuit and the control circuit. An input port of the transforming circuit is connected to a temperature sensor for detecting the temperature of the environment and an input port of the control circuit is connected to a measuring element for measuring the body temperature of a user. Data obtained from the transforming circuit and the control circuit are transferred to the liquid crystal display by the digital signal processor. Therefore, the temperature values of the environments, as well as the body temperature values of users will be displayed on the mobile storage apparatus.

### BACKGROUND OF THE INVENTION

1. Field of the Invention

The present invention relates to a mobile storage apparatus with a temperature detecting function, and especially relates to a mobile storage apparatus such as an MP3 player that measures a temperature of human body or the environment.

2. Description of Related Art

MP3 is a MPEG (moving picture experts group) audio layer-3 compressing standard, and it achieves a compressing ratio 10:1 or 12:1 for data using CD format. The audio quality of MP3 format is as good as music in CD format. Many products are related to the MP3 format, such as, for example, MP3 players.

FIG. 1 shows a schematic diagram of a prior art MP3 playing device, which comprises an MP3 accessing unit 80, an MP3 decompressing unit 81, a random memory unit 82, a file searching unit 83, and a display unit 84. The MP3 accessing unit 80 reads the MP3 data in the CD 85 and stores the same temporally in the random memory unit 82; after that, the data are decompressed by the MP3 decompressing unit 81 and output by an audio device 86.

MP3 products are essential for many people in daily life, and if temperature detecting functions are added to those MP3 products, people may be aware of body temperature values or the environmental temperature at any time. Therefore, people can avoid catching colds.

### SUMMARY OF THE INVENTION

An object of the present invention is to provide a MP3 apparatus with temperature detecting functions, such that the temperature of a human or the environment will be shown on the device.

The MP3 apparatus of the present invention comprises a detecting element for sensing the temperature of the environment. A transforming circuit is connected to the temperature detecting element for transforming the analog temperature values into digital data. A measuring element detects the body temperature. A control circuit is connected to the measuring element for transforming the body temperature values obtained from the measuring element into digital data. A mobile storage device is connected to the transforming circuit, the control circuit and a liquid crystal display. A digital signal processor is set inside the mobile storage device and transfers data obtained from the transforming circuit and the control circuit to the liquid crystal display.

The above-mentioned measuring element is an infrared ray detecting element or a heat-sensing resistance.

The above-mentioned transforming circuit and control circuit may be integrated into a single chip.

### BRIEF DESCRIPTION OF THE DRAWINGS

The various objects and advantages of the present invention will be more readily understood from the following detailed description when read in conjunction with the appended drawing, in which:

FIG. 1 shows a schematic internal circuit block diagram of a prior art MP3 player;

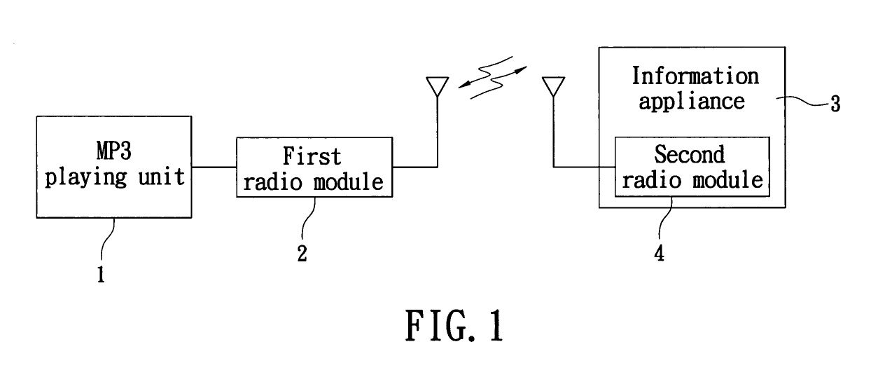

FIG. 2 shows a schematic circuit block diagram of the present invention; and

FIG. 3 shows another schematic circuit block diagram of the present invention.

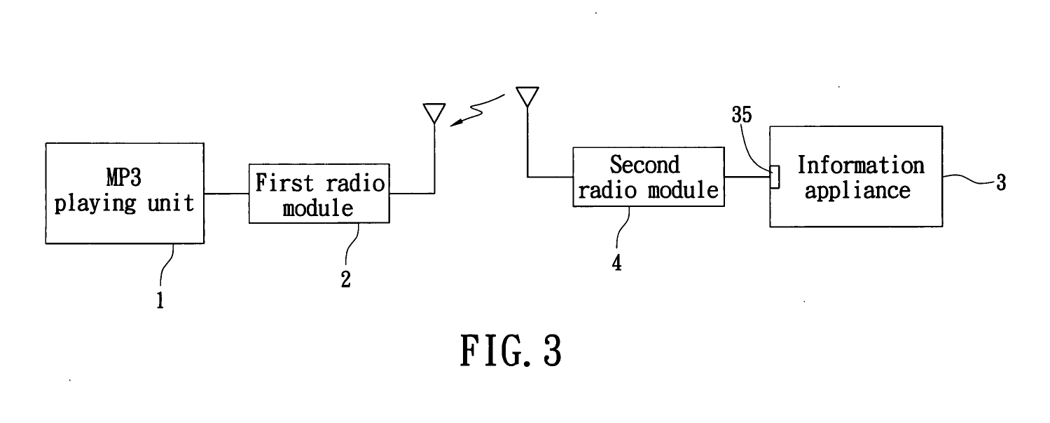

### DETAILED DESCRIPTION OF PREFERRED EMBODIMENTS

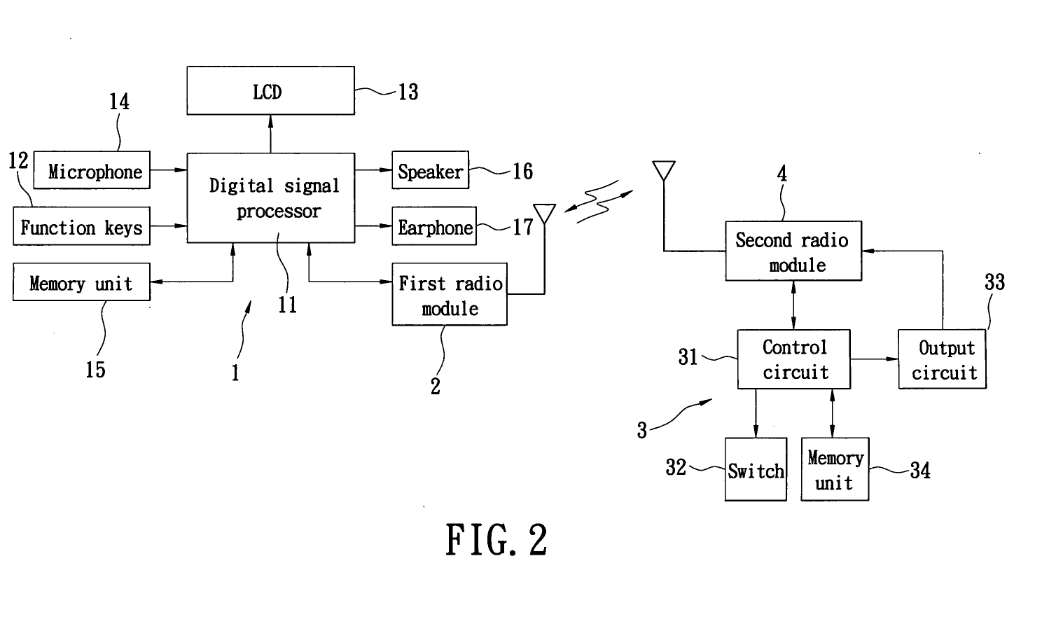

FIG. 2 shows a schematic block diagram of a circuit in the present invention. The present invention provides a temperature sensor 1, a transferring circuit 2, a measuring element 3 a control circuit 4, and a mobile storage device 5. The temperature sensor 1 and the measure element 3 are set on the mobile storage device 5. The transferring circuit 2 and the control circuit 4 are set inside the mobile storage device 5 and connected with related circuits of the mobile storage device 5.

The temperature sensor is used for detecting the temperature of the environment.

The transferring circuit 2 is connected to the temperature sensor 1 and transforms the analog temperature values measured by the temperature sensor 1 into digital data for the mobile storage device 5. The value of the data will be displayed on the mobile storage device 5.

The measuring element 3 is used for detecting the body temperature of a user and is an infrared rays detecting element or a heat sensing resistance.

The control circuit 4 is connected to the measuring element 3 and transforms the analog temperature values measured by the measuring element 3 into digital data for the mobile storage device 5. The value of the data will be displayed on the mobile storage device 5.

The mobile storage device 5 can read MP3 data stored on CD-ROMs and memory cards; the data are also decompressed and transformed into analog signals for output by an audio device.

The mobile storage device 5 includes a digital signal processor 51 connected to the transferring circuit 2, the control circuit 4 and a liquid crystal display 52. The digital signal processor 51 may transfer the data obtained from the transferring circuit 2 and the control circuit 4 for display on the liquid crystal display 52.

Play instructions can be executed by operating a function button 53, inputting audio signals by a microphone 54 or reading MP3 data stored in a memory unit 55. Related messages are displayed by the liquid crystal display 52 and the decompressed data are sent to an earphone 56.

Reference is made to FIG. 4. The present invention can be applied in MP3 products using a wireless communicating module (blue-tooth module) and the wireless communicating module is built-in or externally connected with the mobile storage device 5.

Furthermore, the above-mentioned transferring circuit 2 and the control circuit 4 may be integrated in a single chip for transforming the analog data measured by the temperature sensor 1 and/or the measure element 3 into digital data.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. A mobile storage apparatus with temperature detecting function, comprising:
a detecting element for sensing the temperature of the environment;
a transforming circuit connected to the temperature detecting element for transforming the analog temperature values into digital data;
a measuring element for detecting a body temperature of a user;
a control circuit connected to the measuring element for transforming the body temperature obtained from the measuring element into digital data; and
a mobile storage device connected to the transforming circuit, the control circuit and a display module, wherein a digital signal processor is set inside the mobile storage device and the digital data obtained from the transforming circuit and the control circuit are transferred by the digital signal processor and displayed by the display module.

2. The mobile storage apparatus with temperature detecting function as in claim 1, wherein the mobile storage device is an MP3 product.

3. The mobile storage apparatus with temperature detecting function as in claim 1, wherein the mobile storage device is an MP3 product with a wireless transferring function.

4. The mobile storage apparatus with temperature detecting function as in claim 1, wherein the measuring element is an infrared ray detecting element or a heat sensing resistance.

5. The mobile storage apparatus with temperature detecting function as in claim 1, wherein the detecting element and the measuring element are set on the mobile storage apparatus.

6. The mobile storage apparatus with temperature detecting function as in claim 1, wherein the transforming circuit and the control circuit are set inside the mobile storage apparatus.

7. The mobile storage apparatus with temperature detecting function as in claim 6, wherein the transforming circuit and the control circuit are integrated into a single chip.
